(19) United States
(12) Patent Application Publication
(10) Pub. No.: US 2014/0184739 A1
(43) Pub. Date: Jul. 3, 2014

(54) FOREGROUND EXTRACTION METHOD FOR STEREO VIDEO

(71) Applicant: INDUSTRIAL TECHNOLOGY RESEARCH INSTITUTE, Hsinchu (TW)

(72) Inventor: Chi-Chang Kuo, Kaohsiung City (TW)

(73) Assignee: INDUSTRIAL TECHNOLOGY RESEARCH INSTITUTE, HSINCHU (TW)

(21) Appl. No.: 13/931,693

(22) Filed: Jun. 28, 2013

(30) Foreign Application Priority Data
Jan. 2, 2013 (TW) 102100005

(51) Int. Cl. H04N 13/00

(52) U.S. Cl. CPC H04N 13/0007
USPC 348/43

(57) ABSTRACT

A foreground extraction method for stereo videos applied in an image processing apparatus of a video decoder is provided. The method uses a left-eye view image, a right-eye view image, and multiple interview motion vectors thereof from a decoded multi-view video bitstream to calculate the parallax for the horizontal direction between the left-eye image and the right-eye image quickly, thereby reducing operations for extracting the foreground objects in the multi-view video bitstream.

### CROSS REFERENCE TO RELATED APPLICATIONS

This application claims priority of Taiwan Patent Application No. 102100005, filed on Jan. 2, 2013, the entirety of which is incorporated by reference herein.

### BACKGROUND OF THE INVENTION

1. Field of the Invention

The disclosure relates to video processing, and in particular, relates to an image processing apparatus and a foreground extraction method for stereo videos.

2. Description of the Related Art

Individual objects in digital or video images are usually analyzed when implementing related digital image/video applications. The primary step is to perform foreground segmentation to the foreground objects in the images. Foreground segmentation is also regarded as foreground extraction or background subtraction. FIG. 1 is a diagram illustrating foreground extraction of an image. As illustrated in FIG. 1, a foreground image 110 and a background image 120 can be obtained after performing foreground extraction to an image 100.

Following advances in stereoscopic display technologies, different video codec standards are now applying usage of multi-view images. When performing foreground extraction to stereoscopic images, spatial-based, motion-based, and spatial-temporal methods can be used to segment foreground objects of the conventional techniques. Alternatively, conventional depth-based methods can also be used to segment foreground objects. However, there are some deficiencies of these well known techniques, such as: (1) a database has to be built in advance when using conventional spatial-based methods, and a foreground having similar colors with a background cannot be segmented by using the conventional spatial-based method; (2) stationary foreground objects cannot be segmented by using conventional motion-based methods; (3) there is a very high complexity for operations of conventional spatial-temporal methods; and (4) a very expensive depth detecting device may be required to retrieve depth information when using conventional depth-based methods, or the depth information can be obtained by performing stereo matching to the stereoscopic images.

Briefly, the aforementioned stereo matching methods may compare the left-eye view image and the right-eye view image, thereby retrieving a parallax of each pixel in the left-eye/right-eye view images. If the parallax is large, it may indicate that a corresponding pixel is closer to the lens, and the corresponding pixel may be one pixel of the foreground object. If the parallax is small, it may indicate that the corresponding pixel is further away from the lens, and the corresponding pixel may be one pixel of the background object.

Further, rules for multi-view coding have been defined for the H.264 codec standard, which are based on conventional motion estimation and motion compensation methods plus interview motion vectors for video coding. If the aforementioned stereo matching methods are combined with multi-view coding techniques, the video decoder should decode a multi-view video bitstream compatible with the H.264 standard to obtain decoded view images. Then, the video decoder has to perform stereo matching to the decoded view images to retrieve parallax of each pixel before performing procedures for foreground/background segmentation.

### BRIEF SUMMARY OF THE INVENTION

In view of the above, an image processing apparatus and a foreground extraction method for stereo videos are provided. The image processing apparatus and the foreground extraction method may use existing information (e.g. interview motion vectors) in a multi-view video bitstream to estimate the parallax between the left-eye view and the right-eye view quickly, and then extract the foreground object from the view images by determining the shift distance of objects.

A detailed description is given in the following embodiments with reference to the accompanying drawings.

In an exemplary embodiment, an image processing apparatus for use in a video decoder is provided. The apparatus comprises: a storage unit; and an image processing unit configured to receive a left-eye view image, a right-eye view image, and multiple interview motion vectors thereof from a decoded multi-view video bitstream, and generate a first shift map according to the received interview motion vectors, wherein the image processing unit further applies a median filter and a predetermined threshold value to each pixel of the first shift map to generate a second shift map, and wherein the image processing unit further applies the median filter to each pixel of the second shift map to generate a third shift map, The image processing unit further retrieves at least one contour from the third shift map, and generates a contour map according to the retrieved at least one contour. The image processing unit further fills the at least one contour of the contour map to generate a mask map. The image processing unit further retrieves corresponding macroblocks from the left-eye view image and the right-eye view image according to the generated mask map, and generates an output left-eye view image and an output right-eye view image, which has an extracted foreground, by using the retrieved macroblocks. The first shift map, the second shift map, the third shift map, the contour map, and the mask map are stored in the storage unit.

In another exemplary embodiment, a foreground extraction method for stereo videos for use in an image processing apparatus of a video decoder is provided. The method comprises the following steps of: receiving a left-eye view image, a right-eye view image, and multiple interview motion vectors thereof from a decoded multi-view video bitstream, and generating a first shift map according to the received interview motion vectors; applying a median filter and a predetermined threshold value to each pixel of the first shift map to generate a second shift map; applying the median filter to each pixel of the second shift map to generate a third shift map; retrieving at least one contour from the third shift map, and generating a contour map according to the retrieved at least one contour; filling the at least one contour of the contour map to generate a mask map; and retrieving corresponding macroblocks from the left-eye view image and the right-eye view image according to the generated mask map, and generating an output left-eye view image and an output right-eye view image, which has an extracted foreground, by using the retrieved macroblocks.

### BRIEF DESCRIPTION OF THE DRAWINGS

The disclosure can be more fully understood by reading the subsequent detailed description and examples with references made to the accompanying drawings, wherein:

FIG. 1 is a diagram illustrating foreground extraction of an image;

FIG. 2 is a schematic diagram illustrating an image processing apparatus 200 according to an embodiment of the disclosure;

FIG. 3 is a flow chart illustrating the foreground extraction method for stereo videos according to an embodiment of the disclosure;

FIGS. 4A˜4G are diagrams illustrating intermediate results generated by the foreground extraction method for stereo videos according to an embodiment of the disclosure;

FIG. 5 is a flow chart illustrating steps of generating the contour map by the image processing unit 210 according to an embodiment of the disclosure; and

FIG. 6 is a diagram illustrating a current check point and its adjacent pixels according to an embodiment of the disclosure.

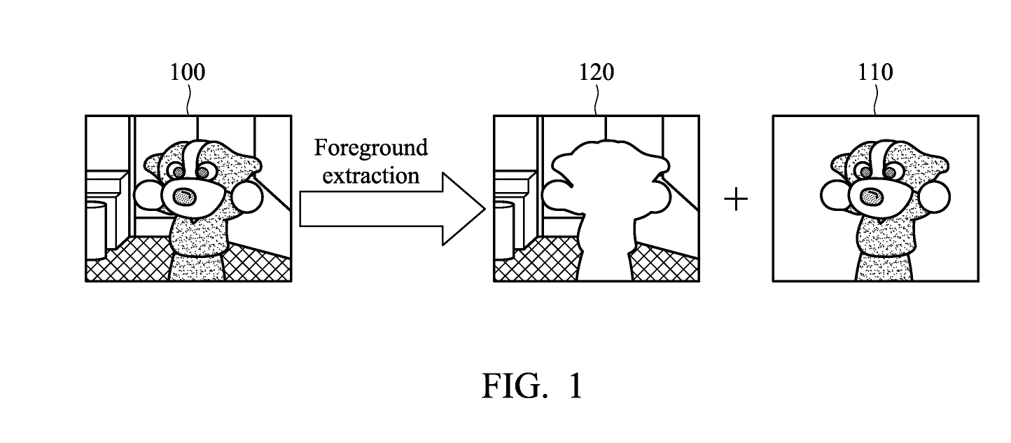

### DETAILED DESCRIPTION OF THE INVENTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

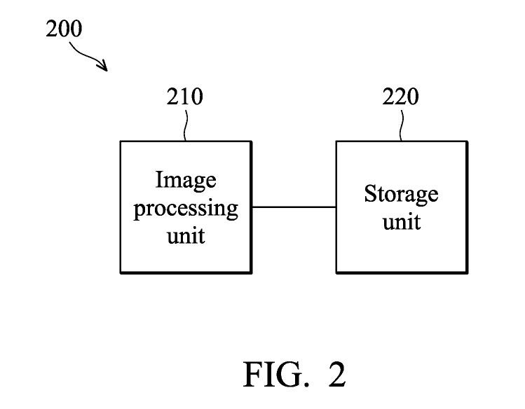

FIG. 2 is a schematic diagram illustrating an image processing apparatus 200 according to an embodiment of the disclosure. In an embodiment, the image processing apparatus 200, which is for use in a video decoder, is configured to receive view images after decoding a multi-view video bitstream, and extract foreground objects, wherein the aforementioned multi-view video bitstream may comprise two view images (e.g. a left-eye view image and right-eye view image) of a stereo video. Specifically, the image processing apparatus 200 may comprise an image processing unit 210 and a storage unit 220, wherein the image processing unit 210 is configured to execute the foreground extraction method for stereo videos of the disclosure, and the storage unit 220 is configured to store intermediate results (e.g. numeric values and image arrays) generated during the execution of the foreground extraction method for stereo videos. Details will be described later. For example, the image processing unit 210 can be implemented by a central processing unit (CPU) or a digital signal processor (DSP) (i.e. software). In addition, the image processing unit 210 may be a specific digital logic circuit (i.e. hardware) for implementing the foreground extraction method for stereo videos of the disclosure. In an embodiment, the storage unit 220 may be a random access memory (e.g. DRAM or SRAM), a flash memory, or a hard disk, but the disclosure is not limited thereto.

In the embodiment, during the multi-view video encoding procedure for the H.264/AVC standard, the video encoder usually encodes one of the two eye images (e.g. taking the right-eye image as the reference image) in the stereo video, and then uses an interview prediction technique to encode another eye image (e.g. the left-eye image). In other words, the video encoder may perform motion estimation and motion compensation to calculate the right-eye image, and then calculate the left-eye image by using the interview motion vectors corresponding to the right-eye image. In addition, there are some corresponding image properties between the left-eye image and the right-eye image in the stereo video. For example, there is a parallax between the left-eye image and the right-eye image, and there is usually a parallax in the horizontal direction (i.e. or slight parallax in the vertical direction). The image processing apparatus 200 and the foreground extraction method for stereo videos of the disclosure may quickly calculate the foreground objects in the multi-view video bitstream by using the parallax in the horizontal direction between the left-eye image and the right-eye image, thereby replacing the stereo matching operations of the conventional video decoders. Accordingly, the operations for extracting the foreground objects from a multi-view coded bitstream of the conventional video decoders can be significantly reduced.

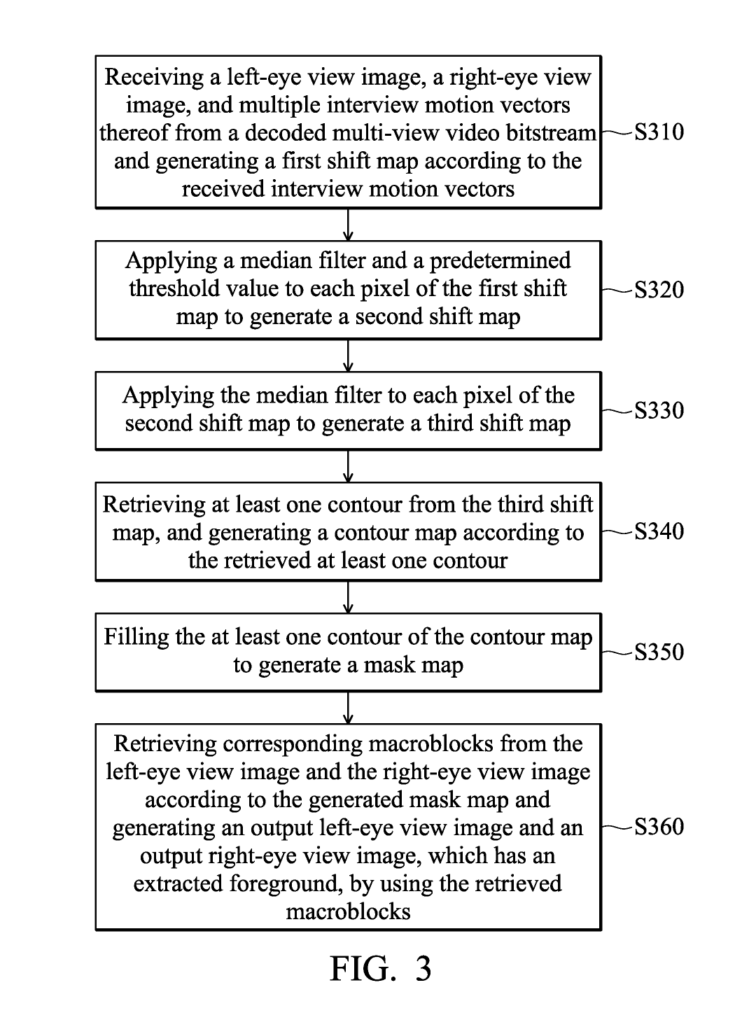

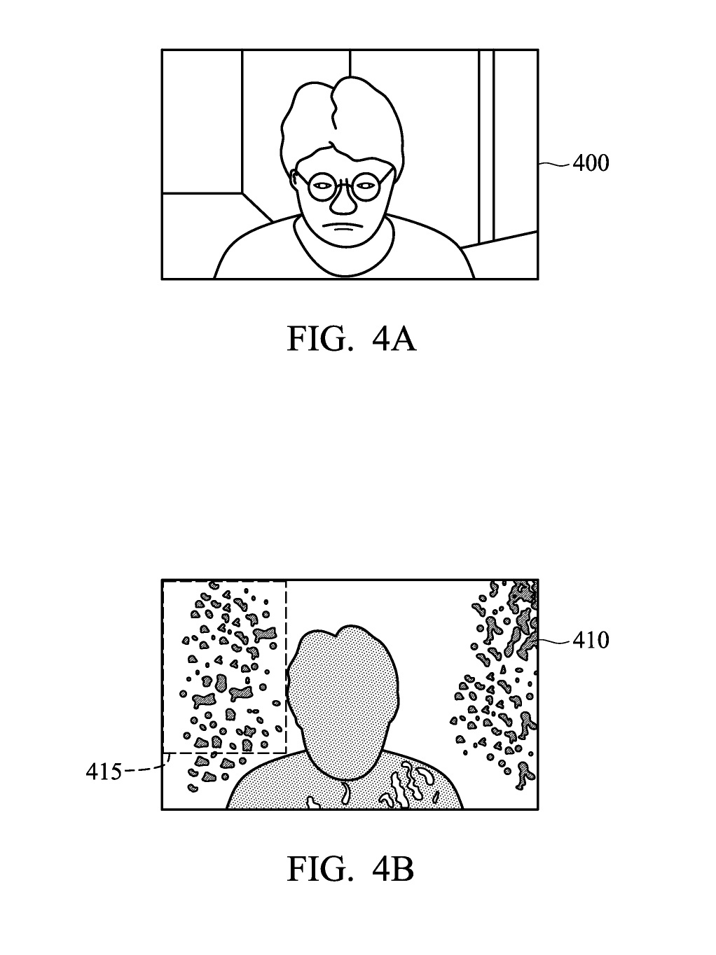

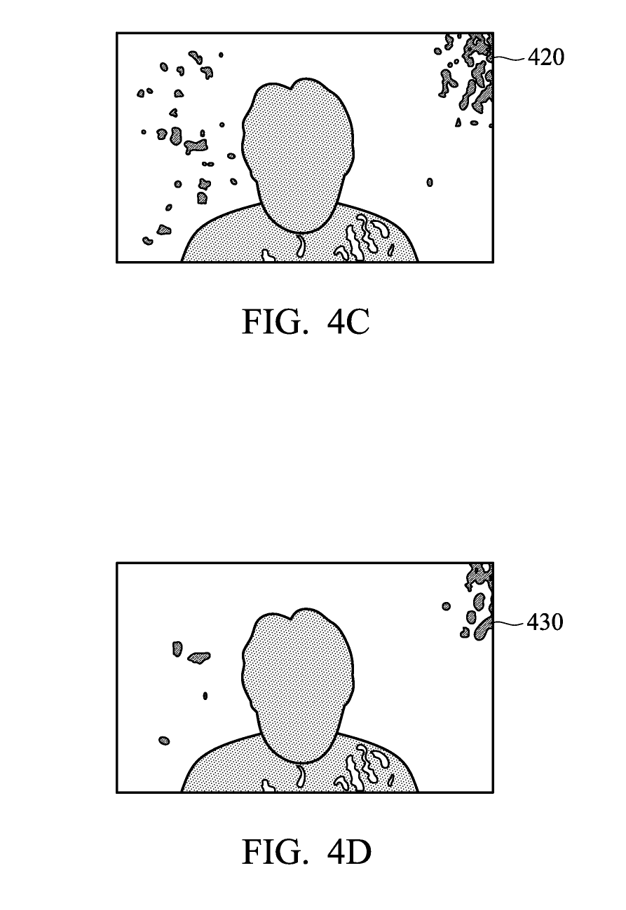

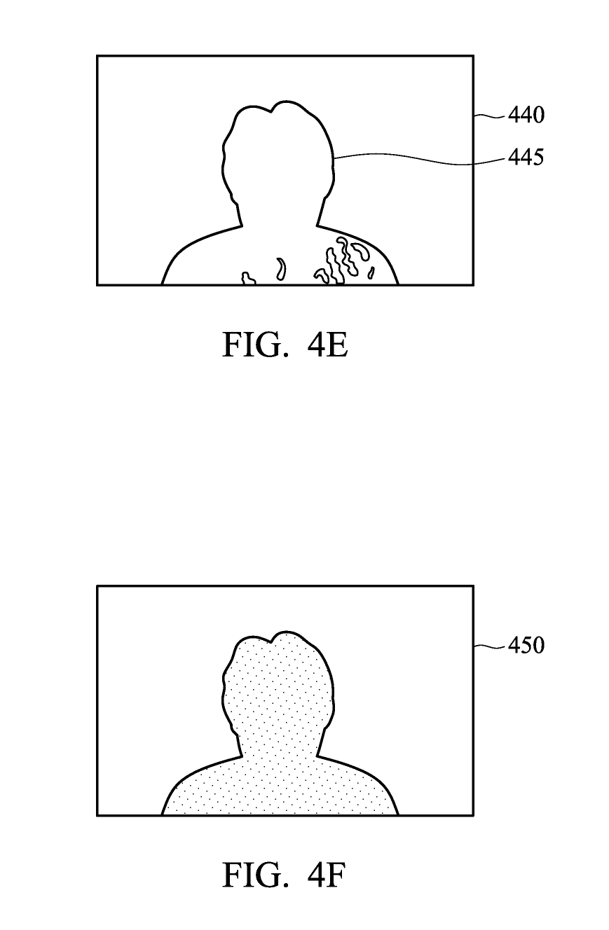

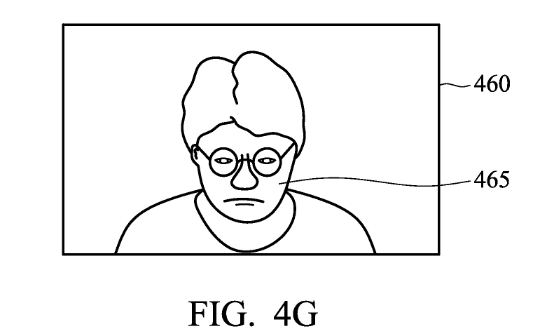

FIG. 3 is a flow chart illustrating the foreground extraction method for stereo videos according to an embodiment of the disclosure. FIGS. 4A˜4G are diagrams illustrating intermediate results generated by the foreground extraction method for stereo videos according to an embodiment of the disclosure. Referring to FIGS. 3 and 4A˜4G, in step S310, the image processing unit 210 may receive a view image (e.g. a right-eye image) 400 and corresponding interview motion vectors after decoding a multi-view video bitstream, and then generate a first shift map 410 according to the received interview motion vectors. The view image 400 is illustrated in FIG. 4A and the first shift map is illustrated in FIG. 4B. Specifically, the image processing unit 210 may calculate the interview motion vectors based on a view image, and the macroblock corresponding to each interview motion vector is divided into 4×4 size. For example, each interview motion vector corresponds to a 16×16 macroblock in the beginning. Then, each 16×16 macroblock is divided into sixteen 4×4 blocks, and the sixteen 4×4 blocks after division correspond to the interview motion vector of the 16×16 macroblock. That is, the sixteen 4×4 blocks have the same interview motion vector.

Given that the resolution of the view image is 1280×720, (1280/4)*(720/4)=320*180=57600 interview motion vectors are generated after the image processing unit 210 divides the view image. Then, the image processing unit 210 may retrieve shift values of the generated interview motion vectors along the horizontal direction (e.g. X-axis), and form the first shift map 410 by using the retrieved shift values. If the resolution of the view image 400 is frame_width*frame_height, the size of the first shift map 410 generated by the image processing unit 210 is ((frame_width/4)*(frame_height/4)). Specifically, the first shift map 410 generated by the image processing unit 210 can be represented by a gray-scale image (e.g. gray levels from 0 to 255). The larger the shift value of a certain interview motion vector along the horizontal direction, the larger the gray level of the corresponding pixels.

In step S320, the image processing unit 210 may apply a median filter and a predetermined threshold value to each pixel of the first shift map 410 to generate a second shift map 420. Specifically, the image processing unit 210 may perform a filtering process to each pixel of the first shift map 410 by using a 3×3 median filter. That is, the median filter may use 9 pixels retrieved from a 3×3 region of each pixel as a center, and the retrieved 9 pixels are sorted into a numeric sequence. Then, the image processing unit 210 may retrieve the fifth largest value in the numeric sequence as the new value of the pixel. After combining the new value of each filtered pixel, a first filtered shift map (not shown) can be obtained. Subsequently, the image processing unit 210 may calculate the number of occurrences of each numeric value (e.g. gray levels 0˜255) for each pixel in the first filtered shift map, and then search for the pixel value with the largest number of occurrences MAX_VALUE. The image processing unit 210 may further calculate the (MAX_VALUE−10) as a lower threshold value, and calculate the (MAX_VALUE+10) as an upper threshold value, wherein the aforementioned predetermined threshold value is 10 in the embodiment. It should be noted that when the aforementioned lower threshold value or upper threshold value is larger than 255 or lower than 0, the image processing unit 210 may clip the lower/upper threshold value to be within the range of 0˜255. Lastly, the image processing unit 210 may perform a clipping process to each pixel in the first filtered shift map by using the generated upper threshold value and lower threshold value.

Further, if the value of each pixel in the first filtered shift map is lower than the lower threshold value or higher than the upper threshold value, the image processing unit 210 may set the value of the corresponding pixel to 0 directly. If the value of each pixel is between the lower threshold value and the upper threshold value, the value of each pixel is maintained. Then, a second shift map 420 can be generated by using each pixel in the first filtered shift map after the clipping process, as illustrated FIG. 4C. Briefly, pixels of the same foreground object usually have similar interview motion vectors between the eye images, thus, the gray values in the first shift map are similar. After step S320, some other interview motion vectors, which significantly differ from the interview motion vectors of the foreground object, can be filtered out, thereby obtaining the second shift map 420.

In step S330, the image processing unit 210 may further apply the aforementioned median filter to each pixel in the second shift map 420 to generate a third shift map 430. That is, a third shift map 430 having more clear interview motion vectors can be obtained after steps S310˜S330, as illustrated in FIG. 4D. It should be noted that, the median filters used in step S330 and S320 are the same, and the filtering methods are also the same. Thus, details will be not described here.

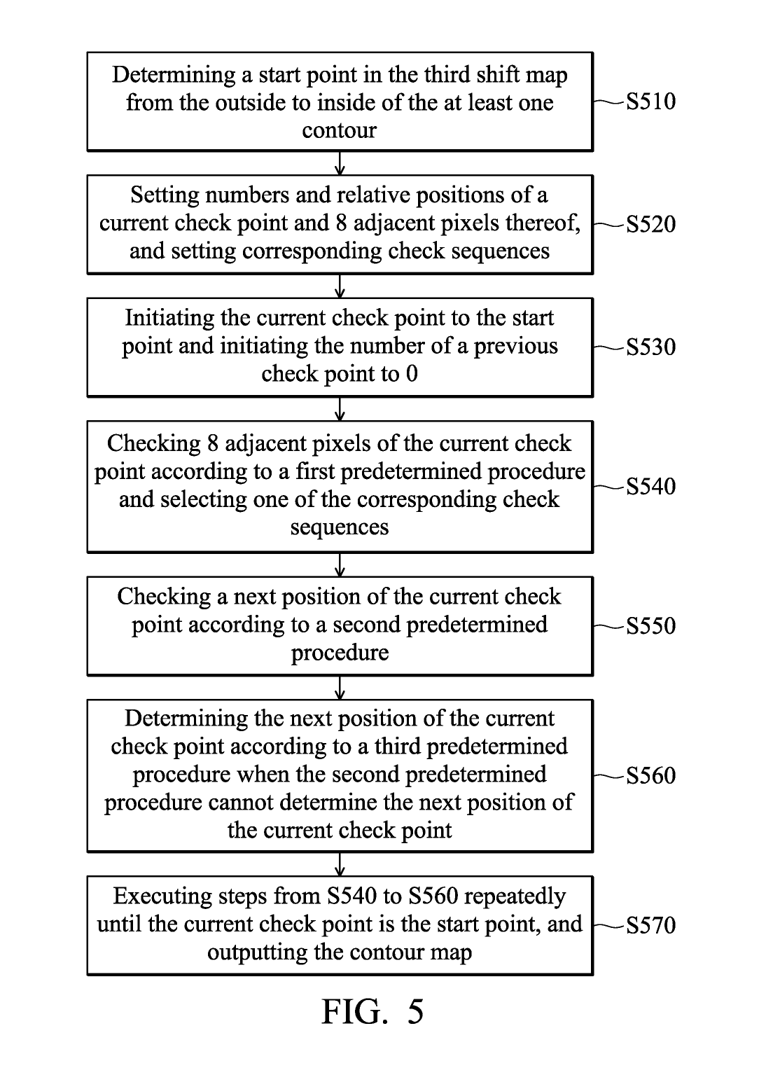

In step S340, the image processing unit 210 may retrieve at least one contour from the third shift map 430, and generate a contour map 440 according to the retrieved contours. Next, the detailed steps of steps S340 will be described in FIG. 5. Referring to FIGS. 3 and 4E, in step S350, the image processing unit 210 may fill the contour 445 in the contour map 440 to generate a mask map 450. Specifically, the image processing unit 210 may determine whether the location (e.g. represented by a coordinate (x,y)) of each pixel of the contour map 440 is located on the inside or along the contour 445 in the contour map 440. If the location of each pixel of the contour map is located on the inside or at the boundary of the at least one contour, the corresponding mask value of the pixel is set to 1. Otherwise, the corresponding mask value of the pixel if set to 0. Then, the mask map 450 can be obtained by combining the mask value of each pixel.

Referring to both FIGS. 3 and 4F, in step S360, the image processing unit 210 may retrieve corresponding macroblocks from the view image 400 according to the generated mask map 450, and generate an output image, having a foreground which has been extracted, according to the retrieved macroblocks. Specifically, the size of the mask 450 generated in step S350 and that of the first shift map 410 are the same. That is, there is a corresponding 4×4 block in the view image 400 for each pixel of the mask map 450. In other words, if a pixel in the mask map 450 has a corresponding mask value 1, the corresponding 4×4 block of the pixel is retrieved from the view image 400. If a pixel in the mask map 450 has a corresponding mask value 0, luminance values of the corresponding 4×4 block of the pixel are set to 0 compulsorily. After all pixels of the mask map 450 are processed by the image processing unit 210, the image processing unit 210 may retrieve corresponding macroblocks from the left-eye view image and the right-eye view image (e.g. view image 400 in FIG. 4A) according to the generated mask map 450, and generate an output left-eye view image and an output right-eye view image (e.g. view image 460) having extracted foregrounds, according to the retrieved macroblocks, as illustrated in FIG. 4G. The foreground extraction method for stereo videos may perform the steps in an order different form that disclosed here.

It should be noted that the shift maps in FIGS. 4B˜4E are illustrated in a white background for description. For those skilled in the art, it is appreciated that FIGS. 4B˜4E in the disclosure are gray-scale images, and the mask map 450 in FIG. 4F is a binary image.

FIG. 5 is a flow chart illustrating steps of generating the contour map by the image processing unit 210 according to an embodiment of the disclosure. Referring to both FIGS. 5 and 4D, in step S510, the image processing unit 210 may determine a start point S(sx,sy) in the third shift map 430 from the outside to inside of the at least one contour, wherein the corresponding value of the location of the start point is not 0. Further, there is no value assigned yet at the location of the start point in the contour map 440. In addition, the start point S(sx,sy) should satisfy one of the following criterion. For example, criteria (a): the start point S(sx,sy) is one of the four vertices of the third shift map 430 (i.e. the up-left vertex is (0.0), positive values toward the right of the X-axis, and toward the down of the Y-axis). That is, sx=0 or sx=map_width−1, and sy=0 or sy=map_height−1, and criteria (b): one of the adjacent pixels of the pixel, which has the coordinate (sx,sy) in the third shift map 430, is zero. The steps of generating the contour map may perform in an order different form that disclosed here.

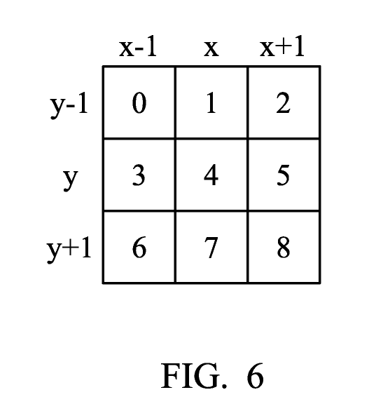

FIG. 6 is a diagram illustrating a current check point and its adjacent pixels according to an embodiment of the disclosure. Referring to both FIG. 5 and FIG. 6, in step S520, the image processing unit 210 may set numbers and relative locations of the current check point C(x,y) and its 8 adjacent pixels, as illustrated in FIG. 6. The image processing unit 210 may further set corresponding 8 check sequences L0˜L3 and L5˜L8, wherein each check sequence comprises 8 points to be checked. The checking order for the 8 points in each check sequence is from left to right. The pixel No. 4 is the current check point, and pixels No. 0˜3 and 5˜8 are the 8 adjacent pixels of the current check point. The check sequences L0˜L3 and L5˜L8 can be expressed as the following:

L0={8,5,7,2,6,1,3,0};

L1={7,6,8,3,5,0,2,1};

L2={6,3,7,0,8,1,5,2};

L3={5,2,8,1,7,0,6,3};

L5={3,0,6,1,7,2,8,5};

L6={2,1,5,0,8,3,7,6};

L7={1,0,2,3,5,6,8,7}; and

L8={0,1,3,2,6,5,7,8},

wherein the numbers in each check sequence may indicate the pixel numbers illustrated in FIG. 6.

Referring to FIG. 5 again, in step S530, the image processing unit 210 may initiate the current check point C(x,y) as the start point S(sx,sy), and initiate the number of the previous check point pos_pre as 0.

In step S540, the image processing unit 210 may check whether the 8 adjacent pixels of the current check point are candidate pixels of contour according to a first predetermined procedure. Specifically, if the current check point C(x,y) is located at the boundary of the third shift map 430, the image processing unit 210 may set the adjacent pixels located on the outside of the boundary to 0 (i.e. only pixels satisfying the boundary condition will be processed). Then, the image processing unit 210 may determine whether the pixels No. 0˜3 and 5˜8 are the candidate pixels of the contour, respectively. That is, the image processing unit 210 may determine the condition indicating that the pixel (i.e. one of pixels No. 0˜3 and 5˜8) is not 0 and one of its adjacent pixels in the horizontal direction and vertical direction is 0. In a special condition, if only two pixels are determined as the candidate pixels of the contour, the image processing unit 210 may further determine whether one of the two candidate pixels has been searched (i.e. the candidate pixel number is exactly the number of the previous check point pos_pre). If the location of each pixel of the contour map is located on the inside or at the boundary of the at least one contour, the image processing unit 210 may check the other pixel, which has not been processed, to search for the contour. Then, the image processing unit 210 may set a corresponding check sequence according to the number of the previous check point pos_pre. For example, if the value of pos_pre is 3, the check sequence L3 is chosen.

In step S550, the image processing unit 210 may determine a next position of the current check point C(x,y) according to a second predetermined procedure. Specifically, the image processing unit 210 may determine which one of the candidate pixels from the 8 adjacent pixels of the current check point C(x,y) in step S540 is the pixel of the contour and it becomes the next check point. The order for determining the candidate pixels is according to a numeric sequence predefined in the chosen check sequence in step S540. The first candidate pixel found in the check sequence is determined as the pixel of the contour. The image processing unit 210 may set the value of the corresponding pixel located at the location of the first candidate pixel as the value of the first candidate pixel, and adjust the number of the previous check point correspondingly to the number of an opposite position of the first candidate pixel in FIG. 6. If no appropriate candidate pixel of the contour is found in step S550, step S560 is performed. Briefly, the empty position in the contour map is determined as the next check point in step S550.

In step S560, when the second predetermined procedure cannot determine the next position of the current check point, the image processing unit 210 may further determine the next position of the current point C(x,y) according to a third predetermine procedure. Specifically, when the adjacent pixels of the current check point C(x,y) are not empty positions, the image processing unit 210 may determine the next position of the current check point C(x,y) according to the number of the previous check point pos_pre.

In step S570, the image processing unit 210 may execute steps S540˜S560 until the current check point C(x,y) is S(sx,sy), and output the contour map 440. That is, the searching results may indicate the contour 445 in the contour map 440.

In an embodiment, the aforementioned image processing apparatus, could be implemented as logic circuit components, and be used to execute the aforementioned functions. In an embodiment, the software programs or firmware programs are used for implementing the aforementioned functions are loaded into the processor or processing unit to execute the aforementioned functions.

In view of the above, an image processing apparatus and a foreground extraction method for stereo videos is provided in the disclosure. The image processing apparatus and the foreground extraction method for stereo videos are capable of estimating the parallax between the left view and the right view quickly by using existing information (e.g. interview motion vectors) stored in a multi-view video bitstream, and extracting the foreground object from the decoded view images by determining the shift distances of objects.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the disclosure has been described by way of example and in terms of the embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing apparatus for use in a video decoder, comprising:
a storage unit; and
an image processing unit for receiving a left-eye view image, a right-eye view image, and multiple interview motion vectors thereof from a decoded multi-view video bitstream, and generating a first shift map according to the received interview motion vectors,
wherein the image processing unit further applies a median filter and a predetermined threshold value to each pixel of the first shift map to generate a second shift map,
wherein the image processing unit further applies the median filter to each pixel of the second shift map to generate a third shift map,
wherein the image processing unit further retrieves at least one contour from the third shift map, and generates a contour map according to the retrieved at least one contour,
wherein the image processing unit further fills the at least one contour of the contour map to generate a mask map,
wherein the image processing unit further retrieves corresponding macroblocks from the left-eye view image and the right-eye view image according to the generated mask map, and generates an output left-eye view image and an output right-eye view image, which has an extracted foreground, by using the retrieved macroblocks,
wherein the first shift map, the second shift map, the third shift map, the contour map, and the mask map are stored in the storage unit.

2. The image processing apparatus as claimed in claim 1, wherein the image processing unit further applies the median filter to sequentially calculate a first intermediate value from a first sequence comprising each pixel and 8 adjacent pixels thereof in the first shift map.

3. The image processing apparatus as claimed in claim 2, wherein the image processing unit further determines a value with a largest number of occurrences from the filtered first intermediate values, sets a summation value of the value and the predetermined threshold value as an upper threshold value, sets a difference value between the value and the predetermined threshold value as a lower threshold value, and reserves the first intermediate values between the upper threshold value and the lower threshold value to generate the second shift map.

4. The image processing apparatus as claimed in claim 3, wherein the image processing unit further applies the median filter to sequentially calculate a second intermediate value from a second sequence comprising each pixel and 8 adjacent pixels thereof in the second shift map, and generates the third shift map according to the calculated second intermediate values.

5. The image processing apparatus as claimed in claim 1, wherein the image processing unit further determines a start point in the third shift map from the outside to inside of the at least one contour, sets numbers and relative positions of a current check point and 8 adjacent pixels thereof, and sets corresponding check sequences,
wherein the image processing unit further initiates the current check point to the start point, initiates the number of a previous check point to 0, checks whether 8 adjacent pixels of the current check point are candidate pixels of the contour according to a first predetermined procedure, and selects one of the corresponding check sequences,
wherein the image processing unit further determines a next position of the current check point according to a second predetermined procedure, and the image processing unit further determines the next position of the current check point according to a third predetermined procedure when the second predetermined procedure cannot determine the next position of the current check point, and
wherein the image processing unit further executes the first predetermined procedure, the second predetermined procedure, and the third predetermined procedure repeatedly until the current check point is the start point, and outputs the contour map.

6. The image processing apparatus as claimed in claim 5, wherein the first predetermined procedure is the image processing unit determining whether the adjacent pixels of the current check point are candidate pixels of the contour, and setting one of the corresponding check sequences according to the number of the previous check point.

7. The image processing apparatus as claimed in claim 5, wherein the second predetermined procedure is the image processing unit determining whether the adjacent pixels of the current check point are empty positions and the candidate pixels of the contour,
wherein the order for determining the candidate pixels is according to a numeric sequence predefined in the selected check sequence,
wherein a first candidate pixel found in the selected check sequence is determined as a pixel of the contour,
wherein the image processing unit further sets a value of a corresponding pixel located at the location of the first candidate pixel as a value of the candidate pixel, and adjusts the number of the previous check point correspondingly to a number of an opposite position of the first candidate pixel.

8. The image processing apparatus as claimed in claim 5, wherein the third predetermined procedure is, when the adjacent pixels of the current check point are not empty positions, the image processing unit further determines the next position of the current check point according to the number of the previous check point.

9. The image processing apparatus as claimed in claim 1, wherein the image processing unit further determines whether the location of each pixel of the contour map is located on the inside or at the boundary of the at least one contour, wherein:
if the location of each pixel of the contour map is located on the inside or at the boundary of the at least one contour, the image processing unit further sets a mask value corresponding to the pixel to 1;
if the location of each pixel of the contour map is not located on the inside or at the boundary of the at least one contour, the image processing unit further sets the mask value corresponding to the pixel to 0; and
the image processing unit further combines the mask value of each pixel of the contour map to generate the mask map.

10. The image processing apparatus as claimed in claim 1, wherein any one of the interview motion vectors has a corresponding 4×4 block in the left-eye view image and the right-eye view image.

11. A foreground extraction method for stereo videos applied in an image processing apparatus of a video decoder, the foreground extraction method comprising:
receiving a left-eye view image, a right-eye view image, and multiple interview motion vectors thereof from a decoded multi-view video bitstream;
generating a first shift map according to the received interview motion vectors;
applying a median filter and a predetermined threshold value to each pixel of the first shift map to generate a second shift map;
applying the median filter to each pixel of the second shift map to generate a third shift map;
retrieving at least one contour from the third shift map, and generating a contour map according to the retrieved at least one contour;
filling the at least one contour of the contour map to generate a mask map;
retrieving corresponding macroblocks from the left-eye view image and the right-eye view image according to the generated mask map; and
generating an output left-eye view image and an output right-eye view image, which has an extracted foreground, by using the retrieved macroblocks.

12. The method as claimed in claim 11, wherein the step of generating the second shift map further comprises:
applying the median filter to sequentially calculate a first intermediate value from a first sequence comprising each pixel and 8 adjacent pixels thereof in the first shift map.

13. The method as claimed in claim 12, wherein the step of generating the second shift map further comprises:
determining a value with a largest number of occurrences from the filtered first intermediate values;
setting a summation value of the value and the predetermined threshold value as an upper threshold value and setting a difference value between the value and the predetermined threshold value as a lower threshold value; and
reserving the first intermediate values between the upper threshold value and the lower threshold value to generate the second shift map.

14. The method as claimed in claim 13, wherein the step of generating the third shift map further comprises:
applying the median filter to sequentially calculate a second intermediate value from a second sequence comprising each pixel and 8 adjacent pixels thereof in the second shift map, and generate the third shift map according to the calculated second intermediate values.

15. The method as claimed in claim 11, wherein the step of generating the contour map further comprises:
determining a start point in the third shift map from the outside to inside of the at least one contour;
setting numbers and relative positions of a current check point and 8 adjacent pixels thereof and setting corresponding check sequences;
initiating the current check point to the start point, initiating the number of a previous check point to 0, checking whether 8 adjacent pixels of the current check point are candidate pixels according to a first predetermined procedure, and selecting one of the corresponding check sequences;
determining a next position of the current check point according to a second predetermined procedure;
determining the next position of the current check point according to a third predetermined procedure when the second predetermined procedure cannot determine the next position of the current check point; and
executing the first predetermined procedure, the second predetermined procedure, and the third predetermined procedure repeatedly until the current check point is the start point, and outputting the contour map.

16. The method as claimed in claim 15, wherein the first predetermined procedure comprises:
determining whether the adjacent pixels of the current check point are candidate pixels of the contour; and
setting one of the corresponding check sequences according to the number of the previous check point.

17. The method as claimed in claim 15, wherein the second predetermined procedure comprises:
determining whether the adjacent pixels of the current check point are empty positions and the candidate pixels of the contour,
wherein the order for determining the candidate pixels is according to a numeric sequence predefined in the selected check sequence,
wherein a first candidate pixel found in the selected check sequence is determined as a pixel of the contour,
wherein the image processing unit further sets a value of a corresponding pixel located at the location of the first candidate pixel as a value of the candidate pixel, and adjusts the number of the previous check point correspondingly to a number of an opposite position of the first candidate pixel.

18. The method as claimed in claim 17, wherein the third predetermined procedure comprises:
determining the next position of the current check point according to the number of the previous check point, c when the adjacent pixels of the current check point are not the empty positions.

19. The method as claimed in claim 11, wherein the step of generating the mask map further comprises:
determining whether the location of each pixel of the contour map is located on the inside or at the boundary of the at least one contour;
if the location of each pixel of the contour map is located on the inside or at the boundary of the at least one contour, the image processing unit further sets a mask value corresponding to the pixel to 1;
if the location of each pixel of the contour map is not located on the inside or at the boundary of the at least one contour, the image processing unit further sets the mask value corresponding to the pixel to 0; and
combining the mask value of each pixel of the contour map to generate the mask map.

20. The method as claimed in claim 11, wherein any one of the interview motion vectors has a corresponding 4×4 block in the left-eye view image and the right-eye view image.
